(19) United States
(12) Patent Application Publication
(10) Pub. No.: US 2008/0055290 A1
(43) Pub. Date: Mar. 6, 2008

(54) Field sequential image display method and apparatus

(75) Inventors: Jun Someya, Tokyo (JP); Shuichi Kagawa, Tokyo (JP); Takahiko Yamamuro, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/826,932

(22) Filed: Jul. 19, 2007

(30) Foreign Application Priority Data
Sep. 4, 2006 (JP) 2006-238852

(51) Int. Cl. G09G 5/00

(52) U.S. Cl. 345/204

(57) ABSTRACT

A field sequential color display is obtained by successive display of a sequence of monochrome images of different colors. Monochrome images in at least one of the colors are displayed with light of two different brightness levels, the light of the lower brightness being used to display comparatively low gray levels, the light of both the lower and higher brightness levels being used to display comparatively high gray levels. This scheme provides extra resolution at the low end of the gray scale, and increases the number of displayable gray levels by counteracting the loss of gray levels that occurs due to gamma correction.

### BACKGROUND OF THE INVENTION

1. Field of the Invention

The present invention relates to a field sequential color image display method and apparatus.

2. Description of the Related Art

The field sequential display method, which obtains a color image by using a single-element light valve to display a sequence of monochromatic images in different colors, enables the color modulator to be configured as a single compact, inexpensive device, and is widely used in projectors and projection television sets.

In relation to a subfield driving method for a plasma display, Japanese Patent No. 2932686 describes a method of reproducing a gray scale by the temporally overlapping display of a temporally weighted series of bi-level images (page 2 and FIG. 2). In a field sequential color display of the micromirror type, in which the gray scale is expressed by different reflection times of the micromirrors, Japanese Patent Application Publication No. 2000-259127 (paragraph 0024 and FIG. 1) describes technology for improving image quality by using predetermined combinations of reflection times. A problem with both of these schemes is that the brightness of the display varies linearly with the reflection time, so in order to implement the type of display characteristic that is generally used in display apparatus, such as the γ^{2.2} gamma characteristic, the gray scale must be converted, but the conversion process reduces the number of gray levels that are actually displayed.

### SUMMARY OF THE INVENTION

An object of the present invention is to provide a field sequential color display method and apparatus that can reproduce more gray levels than before.

The present invention provides a field sequential color display method for obtaining a color image by successively displaying a sequence of images of different colors. The image of at least one of the colors is displayed by modulating and combining first light having a first brightness and occupying a first wavelength region and second light having a second brightness and occupying a second wavelength region. The second brightness exceeds the first brightness. The second wavelength region may be identical to or may differ from the first wavelength region. Comparatively low gray levels in this image are displayed using the first light. Comparatively high gray levels in this image are displayed using both the first and second light.

By providing extra resolution at the low end of the gray scale, this scheme increases the number of gray levels that can be displayed following gray scale conversion.

### BRIEF DESCRIPTION OF THE DRAWINGS

In the attached drawings:

FIG. 1 is a block diagram of a field sequential color display apparatus according to a first embodiment of the invention;

FIG. 2 is a plan view of the color selector in FIG. 1;

FIGS. 3A and 3B are graphs showing an exemplary relation of changes in the brightness of light output from the light source 1 to the sequence in which the colors of light are selected by the color selector 3 in FIG. 2;

FIG. 4 is a graph showing examples of the allocation of gray levels to the first light and second light in the first embodiment;

FIG. 5 is a graph showing the relation of displayed luminance L to the input image data Va and the gray scale data W supplied to the light valve in conventional apparatus;

FIGS. 6 and 7 are graphs illustrating conventional gray scale conversion;

FIG. 8 is a graph showing an exemplary relation of displayed luminance to gray scale data values in the first embodiment;

FIGS. 9A, 9B, 10A, and 10B are graphs showing other possible examples of the relations among displayed luminance L, the input image data Va and the gray scale data W supplied to the light valve in the first embodiment, and illustrate the corresponding gray scale conversion characteristic of the gray scale controller;

FIG. 11 is a graph showing further exemplary relations of displayed luminance L to the gray scale data W supplied to the light valve in the first embodiment of the invention;

FIG. 12 shows an alternative configuration of the color selector in the first embodiment;

FIG. 13 is a plan view of the color selector used in a second embodiment of the invention;

FIG. 14 indicates the wavelength regions of light selected by the color selector in the second embodiment;

FIG. 15 indicates the wavelength region of the light output by the light source in the second embodiment;

FIG. 16 indicates the wavelength region of blue light selected by the color selector in the second embodiment;

FIG. 17 indicates the wavelength region of green light selected by the color selector in the second embodiment;

FIG. 18 indicates the wavelength region of first red light selected by the color selector in the second embodiment;

FIG. 19 indicates the wavelength region of second red light selected by the color selector in the second embodiment;

FIGS. 20A and 20B are graphs showing an exemplary relation of the brightness modulation of light output from the light source 1 to the sequence in which the colors of light are selected by the color selector 3 in the second embodiment; and

FIG. 21 is a graph showing examples of the allocation of gray levels to the first red light and second red light in the second embodiment.

### DETAILED DESCRIPTION OF THE INVENTION

Embodiments of the invention will now be described with reference to the attached drawings, in which like elements are indicated by like reference characters.

### First Embodiment

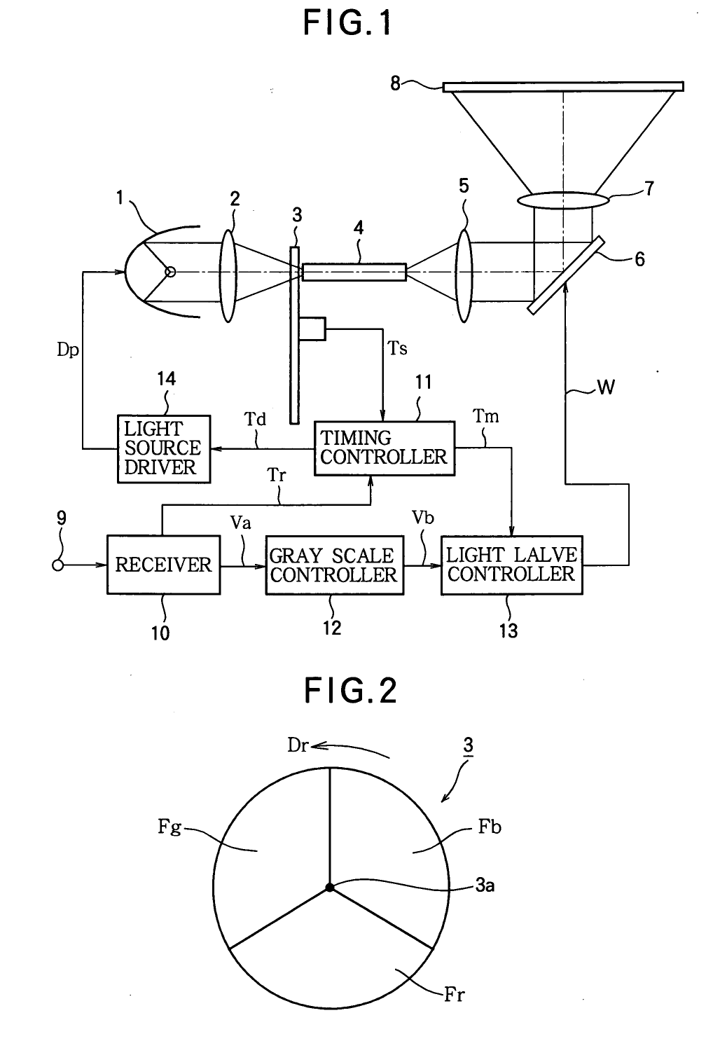

Referring to FIG. 1, the first embodiment is a field sequential color display apparatus in which an image signal input from an input terminal 9 is received by a receiver 10. The receiver 10 outputs image data Va and a timing signal Tr indicating the start of each frame. The timing signal Tr is sent to a timing controller 11. The image data Va are passed to a gray scale controller 12 that performs a gray scale conversion and outputs converted image data Vb.

The timing controller 11 receives color selection timing information Ts from a color selector 3 and the timing signal Tr output from the receiver 10, and outputs a timing signal Tm for operating a light valve controller 13 and a timing signal Td for operating a light source driver 14. The light valve controller 13 generates gray scale data W for the color image from the converted image data Vb according to the timing signal Tm output from the timing controller 11, and outputs the generated gray scale data W to a light valve 6.

The light source driver 14 outputs a signal Dp to the light source 1 to control the brightness of light output from the light source 1 according to the timing signal Td output from the timing controller 11.

Each of the image data Va output from the receiver 10, the image data Vb output from the gray scale controller 12, and the gray scale data W output from the light valve controller 13 consist of, for example, red monochrome image data, green monochrome image data, and blue monochrome image data for displaying the separate fields of the color image.

A light source 1 outputs white light that enters the color selector 3 via a condenser lens 2. The color selector 3 successively selects light with red, green, and blue wavelengths. More specifically, as the light valve controller 13 successively outputs red, green, and blue color data, the color selector 3 successively selects, red, green, and blue light in synchronization with the output of the color data so that the selected color matches the color represented by the data.

The light of the different colors selected in the color selector 3 enters the light valve 6 via a light pipe 4 and an illumination lens 5.

The light valve 6 outputs image light for each picture element (pixel) of the image by on-off pulse width modulation of the light selected by the color selector 3. The gray scale data W supplied from the light valve controller 13 to the light valve 6 determine the on-duration of the image light. When light of each color is selected in each frame duration, each pixel element in the light valve 6 is turned on for a time duration (pulse width) proportional to the gray scale value expressed by the gray scale data W for the corresponding pixel and the selected color. If the light valve 6 is a reflective device such as a digital micromirror device (DMD), a pulse of light with a width proportional to the gray scale value is reflected off the light valve 6. If the light valve 6 is a transmission device, a pulse of light with a width proportional to the gray scale value is transmitted.

The image light generated in the light valve 6 passes through a projection lens 7 and is projected and displayed as an image on the screen 8. The light valve 6 displays a sequence of monochrome images with light of the colors selected by the color selector 3 on the screen, thereby displaying a full-color image.

The color selector 3 comprises a color filter wheel of the type shown in FIG. 2. The color filter wheel is a disc rotatable around an axis 3a, and includes different color filters disposed in different sectors. The color filter wheel includes a green filter Fg, a blue filter Fb, and a red filter Fr. As the color filter wheel turns, light in the wavelength regions transmitted by the color filters is successively selected from the white light output from the light source 1.

In the exemplary color filter wheel in FIG. 2, the area of the sector occupied by the green filter Fg, the area of the sector occupied by the blue filter Fb, and the area of the sector occupied by the red filter Fr are equal, each being one-third of the whole area of the color filter wheel. In general, however, the areas occupied by the red, blue, and green filters Fr, Fb, and Fg may differ.

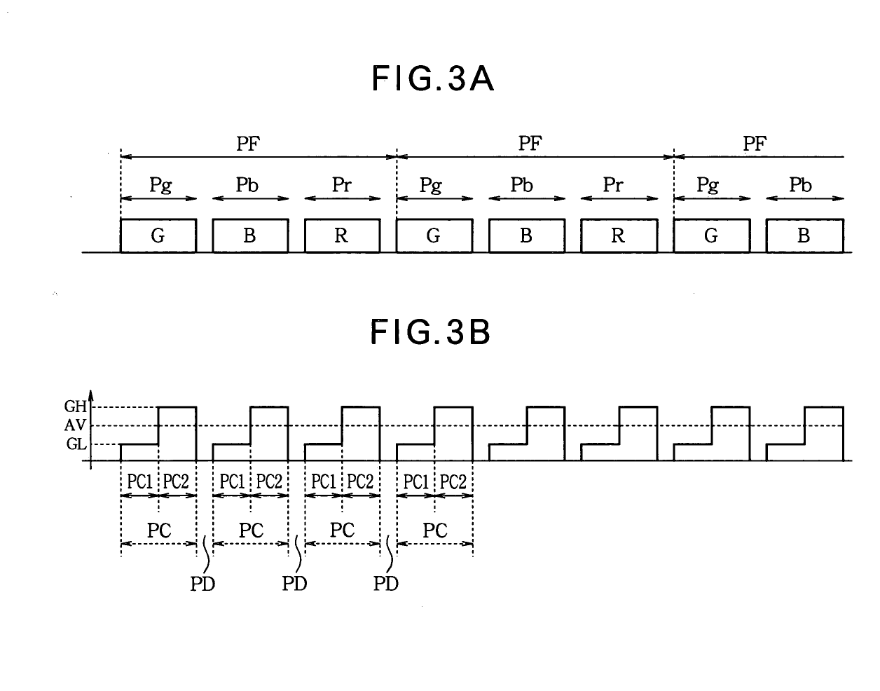

The relation of changes in the brightness of light output from the light source 1 to the sequence in which the colors of light are selected by the color selector 3 in FIG. 2 is illustrated in FIGS. 3A and 3B, where the horizontal axis indicates time. The time sequence in which the colors of light are selected by the color selector 3 is shown in FIG. 3A. As the color filter wheel in FIG. 2 turns in the direction of arrow Dr, the color selector 3 successively selects green light G, blue light B, and red light R, and this sequence is repeated in every frame PF. The changes in the brightness of light output from the light source 1 are shown in FIG. 3B. The light source driver 14 modulates the brightness of the light output from the light source 1 so that the light is reduced to a comparatively low brightness level GL during the first half PC1 of the interval PC during which each monochrome image is displayed, and is raised to a comparatively high brightness level GH during the second half PC2 of the interval PC. The comparatively low level GL is the first brightness referred to in the summary of the invention, and light with the first brightness GL is the first light (also denoted GL); the comparatively high level GH is the second brightness referred to in the summary, and light with the second brightness GH is the second light (GH). These changes in the brightness of light are also referred to as brightness modulation of the light output from the light source 1. The difference between these brightness levels of the modulated light and the average level, or the ratio of this difference to the value of the average level, may be referred to as the modulation index.

Although in FIG. 3B there is an interval PD during which the brightness level is reduced to zero between each two intervals PC in which monochrome images of different colors are displayed, these intervals PD may be eliminated; the interval PC for displaying a monochrome image of one color may start immediately after the interval PC for displaying the monochrome image of the preceding color ends. Similarly, the intervals in FIG. 3A between the selection of different colors may be eliminated. In the description below, it will be assumed that the intervals PD in FIG. 3B are present and that they start and end simultaneously with the corresponding non-selection (non-transmission) intervals in FIG. 3A, so that the intervals Pg, Pb, and Pr in FIG. 3A start and end simultaneously with the corresponding intervals PC in FIG. 3B. In general, the starting and ending times of these intervals may differ slightly.

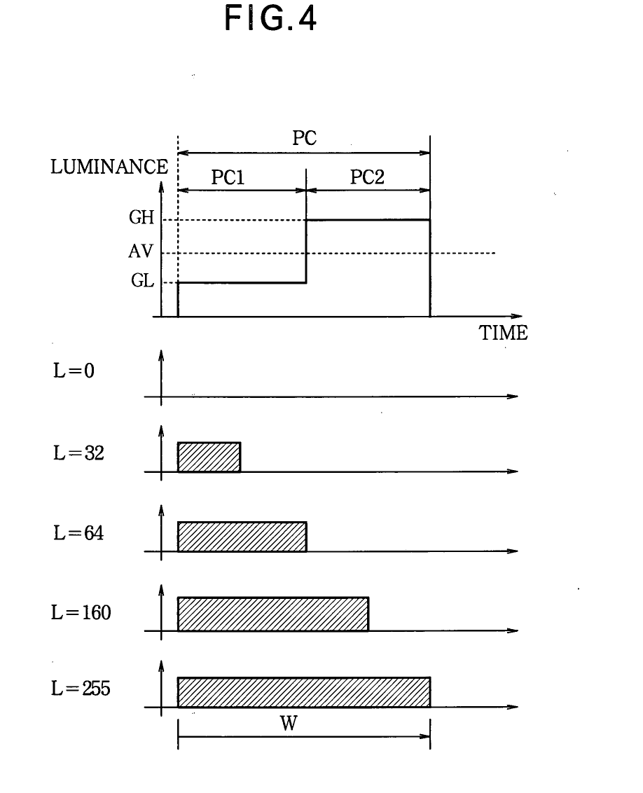

The allocation of gray levels to the first half PC1 and second half PC2 of interval PC is shown in FIG. 4.

In FIG. 4, the interval PC in FIG. 3B during which the color selector 3 selects light of one of the three colors and the corresponding field is displayed is enlarged in the time-axis direction. AV indicates the average of the brightness of light during the interval PC; that is, the average of the brightness GL during the first half PC1 and the brightness GH during the second half PC2, obtained by integrating the brightness value over the interval PC and dividing the integral by the tie duration of the interval PC. The brightness levels GL and GH are adjusted so that their average AV is equal to the brightness level that would be used if the image display apparatus used a constant brightness level.

An example of how eight-bit gray scale data W are displayed is shown in the lower part of FIG. 4, which illustrates the display of five pixels with different gray levels in a given field (red, green, or blue). The brightness level or luminance L of a pixel in the field is proportional to the average brightness of the modulated light of the pixel over the duration of the field.

In the example in FIG. 4, the ratio of the brightness GL of the light from the light source 1 during the first half PC1 of the field to the brightness GH of the light from the light source 1 during the second half PC2 is assumed to be 1:3.

The horizontal axis indicates the reflection time or on-duration of a pixel, which is proportional to the pixel value in the gray scale data W received by the light valve 6. The luminance (L) of a pixel is proportional to the on-duration during interval PC1 plus three times the on-duration during interval PC2. The luminance values in FIG. 4 are scaled so that L=255 represents the maximum luminance level (in the following discussion, the approximation 255=256 is implicitly used).

When the value of the gray scale data W received by the light valve 6 is zero, the light valve 6 reflects neither during the first half PC1 of interval PC in which the light valve 6 receives light with the first brightness GL nor during the second half PC2 in which the light valve 6 receives light with the second brightness GH, so the luminance value L is zero.

When the value of the gray scale data W is 64, the light valve 6 reflects light during half of the first half PC1 of interval PC, and the luminance value L is 32.

When the value of the gray scale data W is 128, the light valve 6 reflects throughout the first half PC1, and the luminance value L is 64.

When the value of the gray scale data W exceeds 128, the light valve 6 reflects throughout the first half PC1 and in part or all of the second half PC2 of interval PC, and the luminance value L exceeds 64. For example, if the value of the gray scale data W is 192, the light valve 6 reflects throughout the first half PC1 and during half of the second half PC2, and the luminance value L is 160.

When the value of the gray scale data W is 255, the light valve 6 reflects throughout the entire interval PC, and the luminance value L is 255.

As described above, pixels with comparatively low gray levels (comparatively dark pixels) are displayed with comparatively dim light GL, and pixels with higher gray levels are displayed with a combination of the comparatively dim light GL and the brighter light GH.

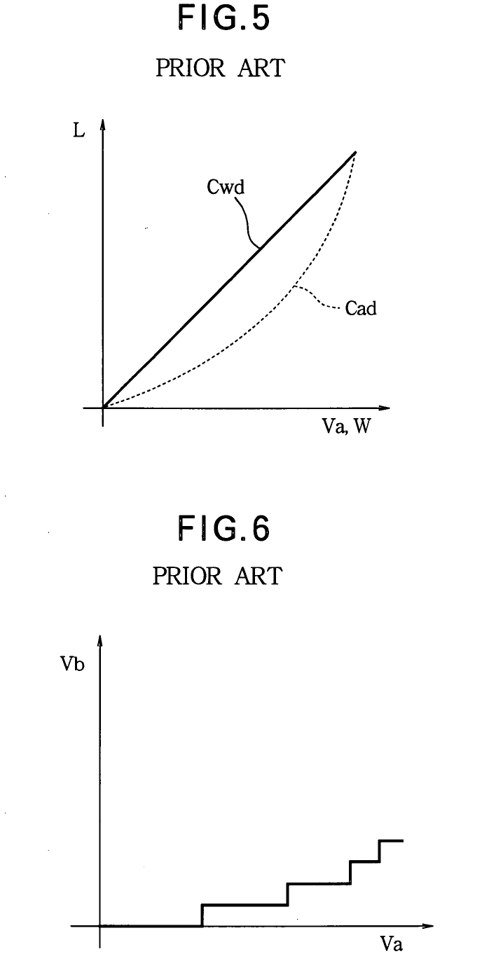

The gray scale conversion characteristic used in conventional display apparatus is illustrated in FIG. 5. The straight line Cwd indicates the operating characteristic of the light valve 6, indicating the relation of pixel luminance L in the displayed image to the gray scale data W supplied to the light valve 6. The dotted curve Cad indicates the desired input-output characteristic (a so-called gamma characteristic) of the display apparatus, relating pixel luminance, L to the input image data Va. Since pixel luminance L varies linearly with the gray scale data W, the gray scale of the input data Va must be converted (the data values must be converted) so that the modulated light will produce the proper luminance L with respect to the input image data Va.

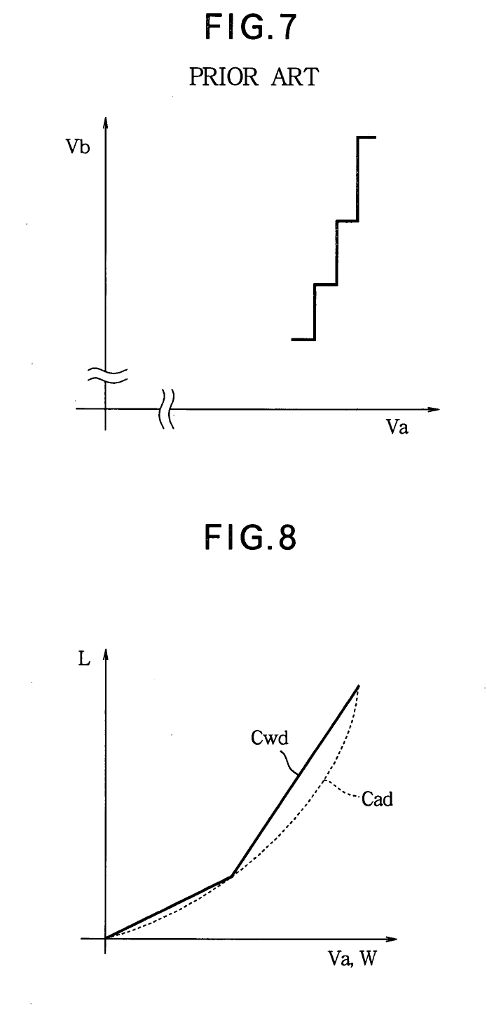

Enlarged parts of the gray scale conversion curve used when the luminance L varies linearly with the gray scale data W are shown in FIGS. 6 and 7: FIG. 6 shows the low end of the gray scale; FIG. 7 shows the high end. The converted image data Vb are linearly related to the gray scale data W output from the light valve controller 13.

As shown in FIG. 6, at the lower end of the gray scale, the input image data Va can change by several gray levels without causing a change in the converted image data Vb. As shown in FIG. 7, at the high end of the gray scale, the converted image data Vb change more than the image data Va and accordingly skip some gray levels. If the image data Va and Vb are both eight-bit data, then although the input image data Va can express 256 gray levels, the converted image data Vb express fewer than 256 gray levels.

FIG. 8 shows the relation of pixel luminance L in the displayed image to the gray scale data. W when the light valve 6 modulates the light with the first brightness GL (first light GL) and second brightness GH (second light GH) as indicated in FIG. 4. As in FIG. 5, the dotted curve Cad represents the desired input-output characteristic (Va to L), and the line marked Cwd represents the operating characteristic of the light valve 6 (W to L). At lower gray levels, when only the first light GL is selected by the color selector 3, the slope of line Cwd is comparatively gentle; at higher gray levels in which both the first light GL and second light GH are used, the slope of line Cwd is comparatively steep. The pixel luminance L therefore does not have a straight linear relation to the gray scale data W received by the light valve 6; the line Cwd is bent so that it more closely approaches the desired input-output curve Cad.

The result is that the W-L relation is already close to the desired Va-L relation, and the gray scale controller 12 does not have to change the input image data Va by very much to obtain the desired pixel luminance levels. Consequently, fewer gray levels are lost in the conversion process, and the number of gray levels that can be displayed increases.

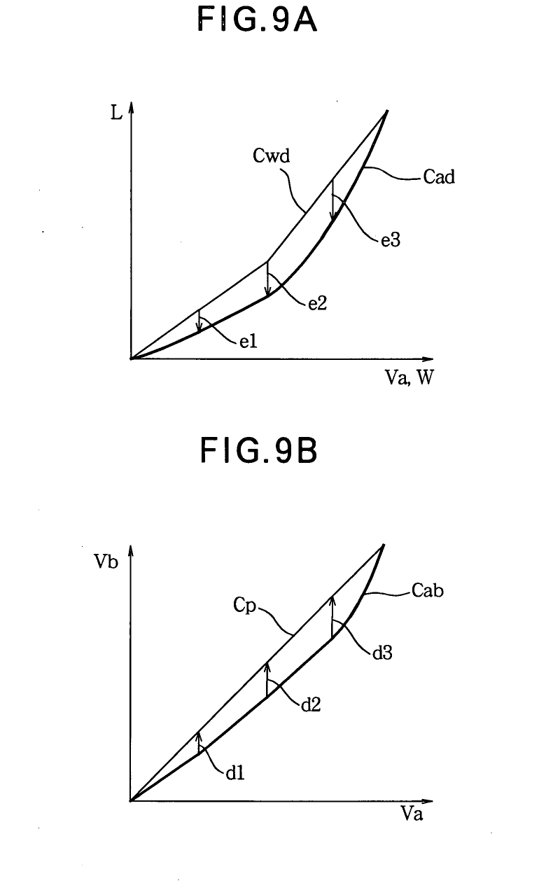

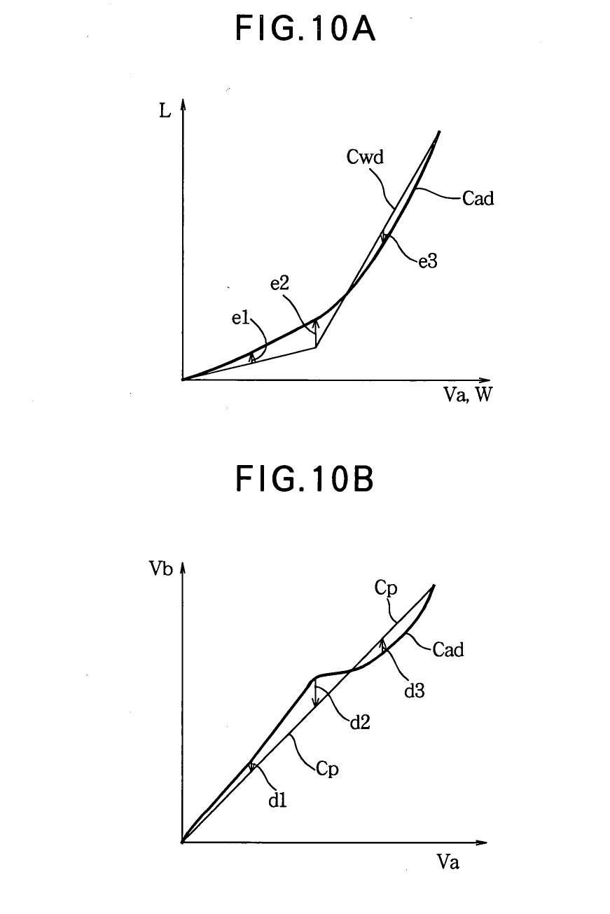

The shape of the bent line Cwd, which is determined by the relative brightness of the first light GL and the second light GH, determines the shape of the conversion curve used in the gray scale controller 12. Placing the bend in line Cwd on the desired gray scale characteristic Cad as in FIG. 8 results in a relatively small loss of gray levels, but other placements are possible. Two examples and the resulting conversion curves are shown in FIGS. 9a, 9b, 10a, and 10b.

In FIGS. 9a and 10a, as in FIG. 5, curve Cad indicates the desired relation of pixel luminance L to the input image data Va and line Cwd indicates the relation of pixel luminance L to the gray scale data W supplied to the light valve 6. The arrows e1, e2, e3 indicate the conversion left to be performed by the gray scale controller 12.

FIGS. 9b and 10b indicate relations between the input image data Va and converted image data Vb. Line Cp indicates the equality relation (Vb=Va). Curve Cab indicates how the gray scale controller 12 converts the input image data Va to the converted image data Vb. Arrows d1, d2, and d3 in FIGS. 9b and 10b are identical to the arrows e1, e2, and e3 in FIGS. 9a and 10a, respectively, with the direction reversed.

When the bend in the Cwd line is placed above the Cad curve as in FIG. 9A, it will be appreciated from FIG. 9B that there is still some loss of gray levels at the low end of the gray scale, although not as much as in FIGS. 5 and 6. When the bend in the Cwd line is placed as far below the Cad curve as in FIG. 10A, there is no loss of gray levels at the low end of the gray scale, where the gray scale is slightly expanded instead of being compressed, but some gray levels are lost in the middle of the gray scale, as can be appreciated from FIG. 10B.

It is not necessary to use equal light levels (equal first brightnesses GL and equal second brightnesses GH) for all three of the primary colors red, green, and blue. The light source driver 14 may control the light source 1 so as to produce different brightness levels for the red, green, and blue fields, respectively.

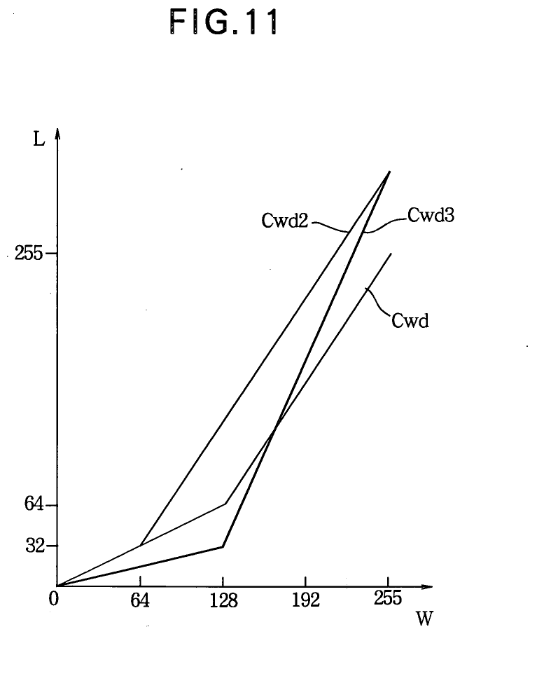

The different shapes of line Cwd in FIGS. 8, 9A, and 10A are obtained by adjustment of the two brightness levels GH and GL in FIGS. 3B and 4, that is, by changing the brightness of the light output from the light source 1. Another type of adjustment can be made by changing the relative lengths of the intervals PC1 and PC2. FIG. 11 shows examples of both types of adjustments.

Line Cwd in FIG. 11 is identical to line Cwd in FIG. 8 (although with different scales on the vertical and horizontal axes), showing the relation of pixel luminance L to the gray scale data W when the intervals PC1 and PC2 have equal lengths, so that half of the gray scale is displayed by the first light GL alone, and the other half is displayed by a combination of first light GL and second light GH.

Line Cwd2 in FIG. 11 shows the relation of pixel luminance L to the gray scale data W when the length of interval PC1 is one-third of the length of interval PC2. Now the lower one-fourth of the gray scale is displayed by use of the first light GL alone, the remaining three-fourths being displayed by a combination of the first light GL and the second light GH. The slope of line Cwd2 changes at the point where the gray scale value of data W is 64 (one-fourth of the maximum gray scale value). The maximum displayable luminance level is increased, resulting in a wider gamut of reproducible colors.

Line Cwd3 in FIG. 11 shows the relation of pixel luminance L to the gray scale data W supplied to the light valve 6 when the intervals PC1 and PC2 have equal lengths, but the brightness of the first light GL is reduced and the brightness of the second light GH is increased, as compared with the case illustrated in FIG. 8. At the low end of the gray scale, loss of gray levels is eliminated as in FIG. 10a and 10b; at the high end of the gray scale, the maximum displayable luminance level is increased, resulting in a wider gamut of reproducible colors, as with line Cwd2.

As these examples show, by using the first light GL to display pixels with comparatively low gray levels and using both the first light GL and the second light GH to display pixels with higher gray levels, it is possible to reduce the loss of gray levels caused by gray scale conversion, and also to broaden the gamut of reproducible colors.

It is not necessary for the interval PC1 during which the first light GL is selected to precede the interval PC2 during which the second light GH is selected as shown in FIGS. 3B and 4. The order may be reversed: interval PC2 may precede interval PC1. At least one of the intervals PC1 and PC2 may be divided into two or more sub-intervals, and the entire other interval PC1 or PC2, or parts thereof, may be inserted between the divided sub-intervals.

It is not necessary to select the first light GL and the second light GH in consecutive intervals PC1 and PC2. For example, the interval for displaying a monochrome image of each color in each frame may be divided into a plurality of separate intervals, and during each of the divided separate intervals, either the first light GL or the second light GH may be selected.

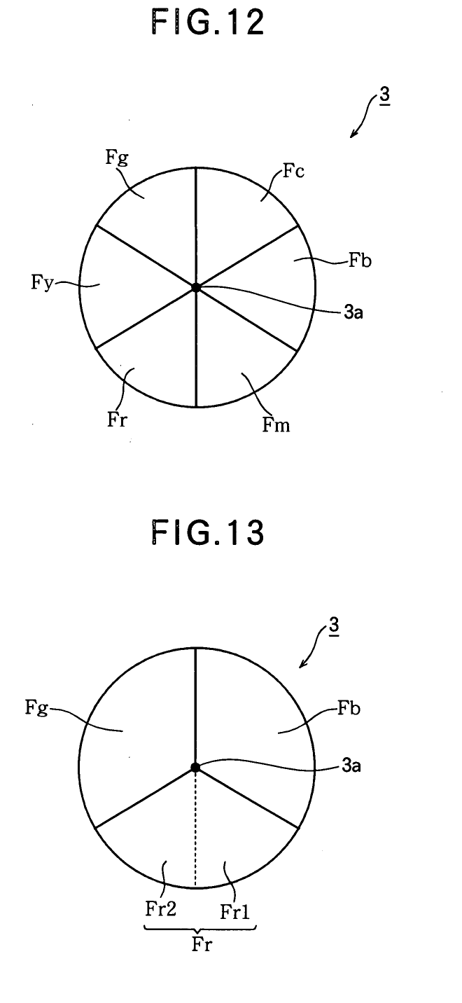

It is not necessary for the color selector 3 to select light of just three primary colors as shown in the example in FIG. 3A. The color selector 3 in the present invention may select more than three colors: for example, the color selector 3 may include a yellow filter Fy, cyan filter Fc, and magenta filter Fm in addition to the red filter Fr, green filter Fg, and blue filter Fb shown in FIG. 12, and yellow (Y), cyan (C), magenta (M) may be added to the three primary colors green, blue, and red.

In these variations, when the color selector 3 selects light of each color, the gray scale data W supplied from the light valve controller 13 to the light valve 6 determine the on-duration of the selected light. To include these alternative configurations of the color selector 3, the color display of the present invention may be generalized as follows.

The color selector 3 successively selects light of N colors from the light output from the light source 1, where N is a positive integer. The gray scale controller 12 converts the gray scale of the input color image data Va for the N colors to generate converted image data Vb for the N colors. While the color selector 3 selects a Jth color among the N colors, the light source 1 outputs, at separate times, at least first light having a first brightness GL and second light having a second brightness GH greater than the first brightness GL, where J is an integer equal to or greater than one and equal to or less than N.

The light valve 6 modulates the light of the color selected by the color selector 3 according to the converted image data output by the gray scale controller 12 for each pixel in the color image, thereby obtaining image light of the N colors. The light valve 6 modulates the light output when the color selector 3 selects a Kth color according to the color image data for the Kth color, where K is any integer equal to or greater than one and equal to or less than N.

If the light valve 6 outputs the image light by on-off pulse width modulation of the light selected by the color selector 3 for each pixel of the image, then when the value of the image data for the Jth color of a pixel expresses a gray level equal to or less than a predetermined level, the light valve 6 modulates only the first light GL to the on-state, and when the value of the image data for the Jth color of a pixel expresses a gray level greater than the predetermined level, the light valve 6 modulates both the first light GL and the second light GH to the on-state.

It is not necessary for the light source driver 14 to control the light source 1 so that the light output from the light source 1 has just two brightness levels; the number of brightness levels may be three or more. An increased number of brightness levels increases the number of different gray levels that can be displayed.

### Second Embodiment

The second embodiment is a field sequential color display apparatus that differs from the first embodiment by including a different light source 1 and a different color selector 3.

The color selector 3 in the second embodiment comprises a color filter wheel of the type shown in FIG. 13. This color filter wheel is a disc rotatable around an axis 3a, having a green filter Fg, a blue filter Fb, and a red filter Fr as in the first embodiment, but the red filter Fr is now divided into two separate filters: a first red filter Fr1 and a second red filter Fr2. As the color filter wheel turns, light in the wavelength regions transmitted by the color filters is successively selected from the white light output from the light source 1.

In the exemplary color filter wheel in FIG. 13, the area of the sector occupied by the green filter Fg, the area of the sector occupied by the blue filter Fb, and the area of the sector occupied by the red filter Fr are equal, each being one-third of the whole area of the color filter wheel. The areas of the sectors occupied by the first and second red filters Fr1 and Fr2 are also equal, each being one-sixth of the whole area of the color filter wheel. In general, however, the areas occupied by the red, blue, and green filters Fr, Fb, and Fg may differ, and the red filters Fr1 and Fr2 may also differ in area.

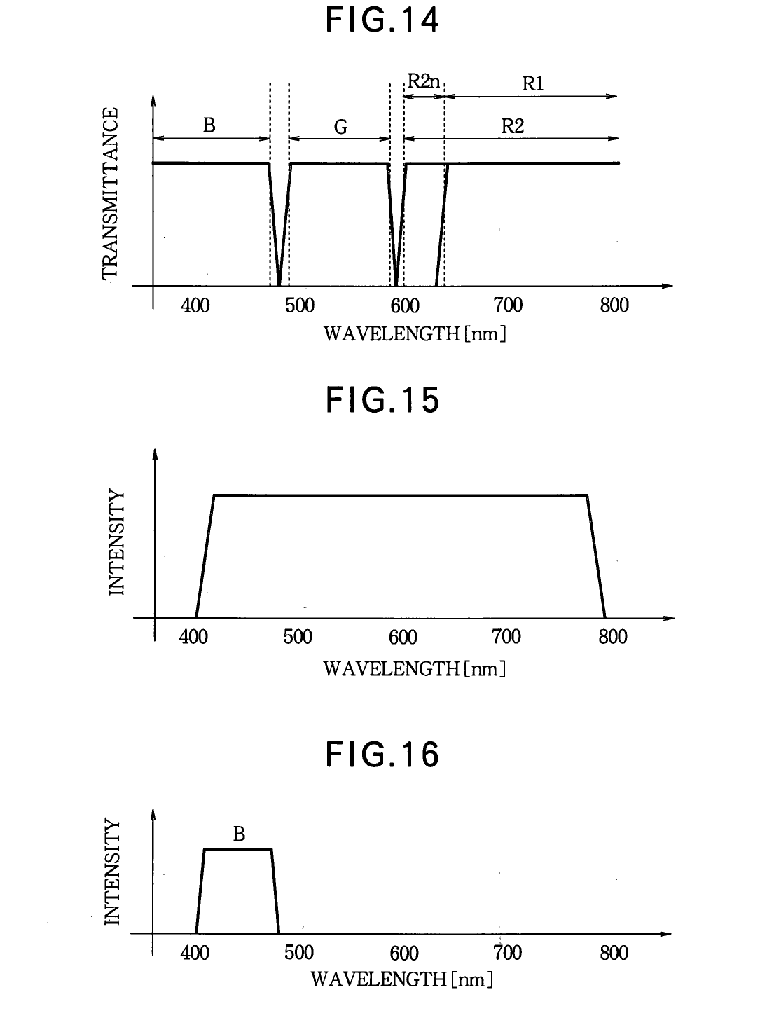

The spectral transmittance characteristics of the color filters in the color selector 3 in FIG. 13 are illustrated in FIG. 14. Wavelengths transmitted by the first red filter Fr1 are also transmitted by the second red filter Fr2, but the second red filter Fr2 transmits some shorter red wavelengths as well. The wavelength region R1 of light that passes through the first red filter Fr1 and the wavelength region R2 of light that passes through the second red filter Fr2 accordingly overlap: the second wavelength region R2 includes part or all of the first wavelength region R1, and also includes a wavelength region of light R2n distinct from but contiguous with the included part of the first wavelength region R1. In this example the first wavelength region R1 is entirely included in the second wavelength region R2, and the contiguous region R2n is contiguous on the short wavelength end of the first wavelength region R1.

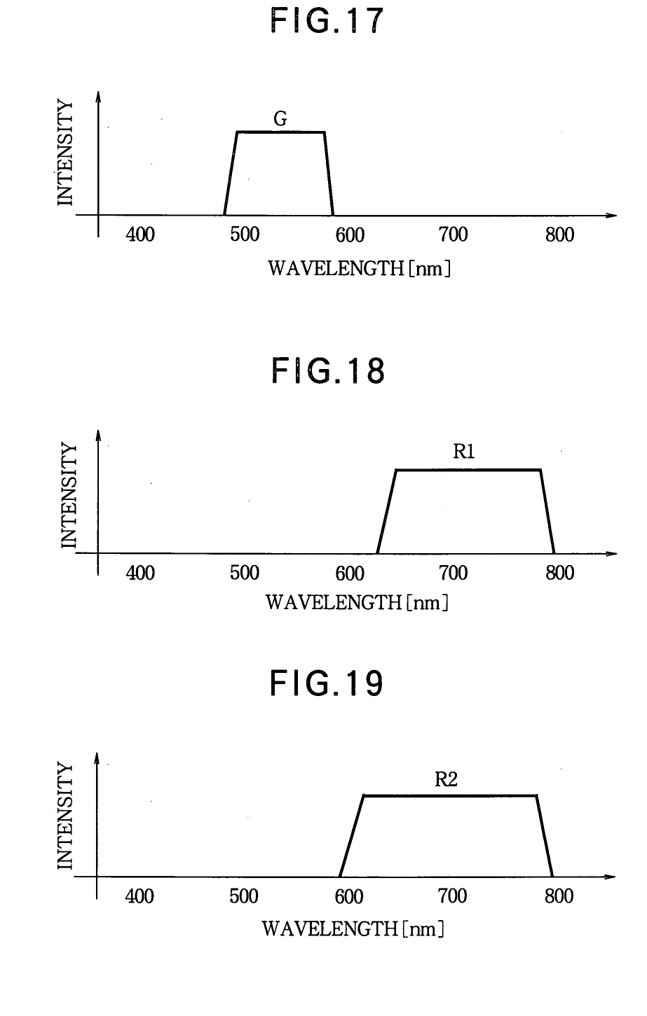

The spectrum of the white light output from the light source 1 includes the entire visible light spectrum as shown in FIG. 15. The spectra (wavelength regions) of the blue light B selected by the blue filter Fb, the green light G selected by the green filter Fg, the first red light R1 selected by the first red filter Fr1, and the second red light R2 selected by the second red filter Fr2 are shown in FIGS. 16, 17, 18, and 19, respectively.

Referring to FIGS. 18 and 19, because the red light R1 selected by the first red filter Fr1 has comparatively high color purity, when the first red light R1 is selected, a comparatively vivid red image is displayed. Because the red light R2 selected by the second red filter Fr2 includes a wider wavelength region, it includes more light, so when the second red light R2 is selected, a brighter red image is displayed.

In the second embodiment, when the red color field is displayed, if the gray level is comparatively low, more specifically, if the gray level indicated by the red color data is equal to or less than a predetermined level, the light valve 6 reflects light when the first red filter Fr1 is selected but not when the second red filter Fr2 is selected, thereby displaying a red color of high purity; if the gray level is comparatively high, more specifically, if the gray level indicated by the red color data exceeds the predetermined level, the light valve 6 reflects light when both the first and second red filters Fr1 and Fr2 are selected, thereby displaying a bright red color.

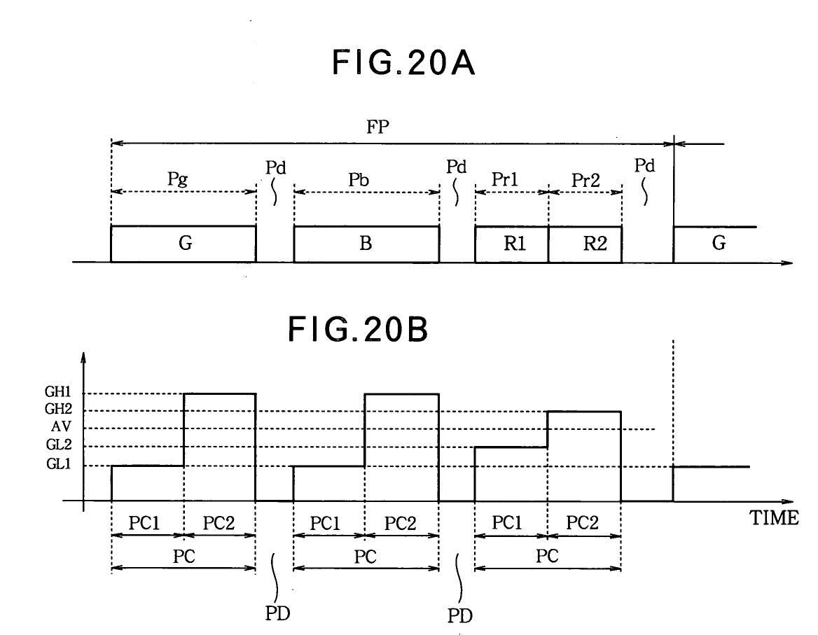

The relation of changes in the brightness of light output from the light source 1 to the sequence in which the colors of light are selected by the color selector 3 is illustrated in FIGS. 20a and 20b, where the horizontal axis indicates time. The time sequence in which the colors of light are selected by the color selector 3 is shown in FIG. 20A. The changes in the brightness (brightness modulation) of light output from the light source 1 are shown in FIG. 20B.

The light source driver 14 modulates the brightness of the light output from the light source 1 so that the light is reduced to a first brightness level GL1 during the first half PC1 of the interval PC corresponding to the interval Pg during which the color selector 3 selects green light G and during the first half PC1 of the interval PC corresponding to the interval Pb during which the color selector 3 selects blue light B, and is raised to a second brightness level GH1 during the second half PC2 of the interval PC corresponding to the interval Pg during which the color selector 3 selects green light G and during the second half PC2 of the interval PC corresponding to the interval Pb during which the color selector 3 selects blue light B.

The light source driver 14 modulates the brightness of the light output from the light source 1 so that the light is reduced to a third brightness level GL2 during the first half PC1 of the interval during which the color selector 3 selects red light R, corresponding to the interval Pr1 during which the first red filter Fr1 selects (transmits) first red light R1, and is raised to a fourth brightness level GH2 during the second half PC2 of the interval during which the color selector 3 selects red light R, corresponding to the interval Pr2 during which the second red filter Fr2 selects (transmits) second red light R2.

As described above, since the areas of the sectors occupied by the first and second red filters Fr1 and Fr2 are equal, the lengths of the interval. Pr1 during which the first red light R1 is selected and the interval Pr2 during which the second red light R2 is selected are also equal, the interval Pr1 being the first half of the interval Pr during which red light R is selected, the interval Pr2 being the second half of the interval Pr.

In the example in FIG. 20B, the second brightness level GH1 is higher than the first brightness level GL1, the fourth brightness level GH2 is higher than the third brightness level GL2, the third brightness level GL2 is higher than the first brightness level GL1, and the fourth brightness level GH2 is lower than the second brightness level GH1.

The first brightness level GL1 in the second embodiment is equal to the first brightness level GL in the first embodiment, and the second brightness level GH1 in the second embodiment is equal to the second brightness level GH in the first embodiment. The color selector 3 accordingly produces the same green light G during interval Pg and the same blue light B during interval Pb as in the first embodiment.

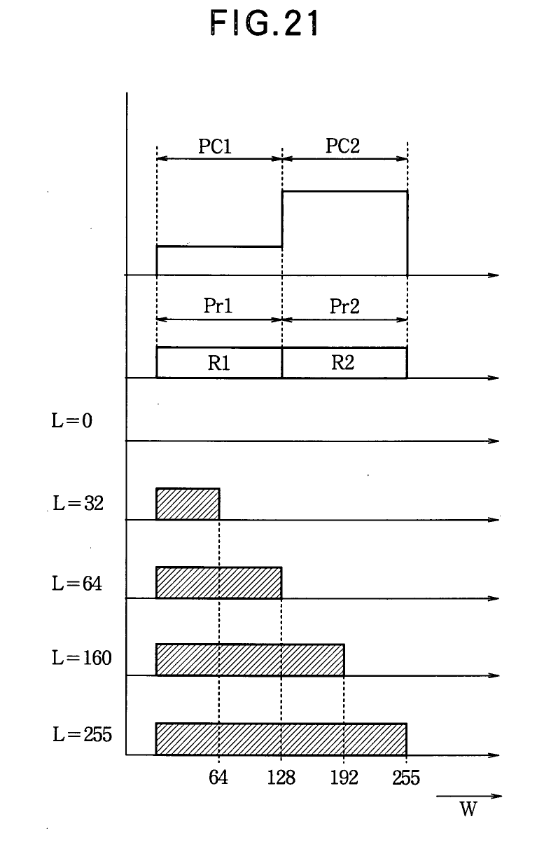

The allocation of gray levels to the first half PC1 (Pr1) and second half PC2 (Pr2) of the red interval Pr is shown in FIG. 21.

As shown in the upper part of FIG. 21, the light source 1 successively outputs light with the third brightness GL2 during interval PC1 and light with the fourth brightness GH2 during interval PC2. The lengths of intervals PC1 and PC2 are equal. The color selector 3 successively selects the first red light R1 during interval Pr1 and the second red light R2 during interval Pr2. Interval PC1 coincides with interval Pr1, and interval PC2 coincides with interval Pr2, so the color selector 3 selects the first red light R1 in synchronization with output of light with the third brightness GL2 from the light source 1, and the second red light R2 in synchronization with output of light with the fourth brightness GH2 from the light source 1.

An example of how eight-bit gray scale data W are displayed for the color red is shown in the lower part of FIG. 21, which illustrates the display of five pixels with different gray levels in a given red field. The brightness level or luminance L of a pixel in the field is proportional to the average brightness of the modulated light of the pixel over the duration of the field.

In the example in the lower part of FIG. 21, the ratio of the brightness of the first red light R1 to the brightness of the second red light R2 is assumed to be 1:3. This ratio is determined by the third brightness GL2 of the light source 1, the width of wavelength region R1 (the passband of the first red filter Fr1), the fourth brightness GH2, and the width of wavelength region R2 (the passband of the second red filter Fr2).

The horizontal axis indicates the gray scale data W received by the light valve 6. The reflection time (on-duration) of each pixel in the light valve 6 is proportional to the gray scale data W. The luminance (L) of a pixel is proportional to the R1 reflection time plus three times the R2 reflection time. The luminance values in FIG. 21 are scaled so that L=255 represents the maximum luminance level (in the following discussion, the approximation 255=256 is implicitly used).

When the value of the gray scale data W received by the light valve 6 is zero, the light valve 6 reflects neither first red light R1 during interval Pr1 nor second red light R2 during interval Pr2, so the luminance value L is zero (in the red field, the pixel is black).

When the value of the gray scale data W is 64, the light valve 6 reflects light during half of the interval Pr1 in which the first red light R1 is selected by the color selector 3, and the luminance value L is 32.

When the value of the gray scale data W is 128, the light valve 6 reflects throughout the interval Pr1 in which the first red light R1 is selected, and the luminance value L is 64.

When the value of the gray scale data W exceeds 128, the light valve 6 reflects throughout the interval Pr1 in which the first red light R1 is selected and in part or all of the interval Pr2 in which the second red light R2 is selected, and the luminance value L exceeds 64. For example, if the value of the gray scale data W is 192, the light valve 6 reflects all of the selected first red light R1 and half of the selected second red light R2, and the luminance value L is 160.

When the value of the gray scale data W is 255, the light valve 6 reflects all the first red light R1 and second red light R2, and the luminance value L is 255.

As described above, red pixels with comparatively low gray level data (comparatively dark red pixels) are displayed with red light R1 of high color purity, and red pixels with higher gray levels are displayed with a combination of the high-purity first red light R1 and the brighter second red light R2. Accordingly, at comparatively low gray levels, the color selector 3 and light valve 6 can display a color image with deep reds of high color purity, and at comparatively high gray levels, the color selector 3 and light valve 6 can display an image with enhanced red brightness. The gamut of reproducible colors is thereby extended.

A fundamental problem of color displays is that they operate by emitting light while most subjects in nature are seen by reflected light. A subject that reflects only a narrow range of deep red wavelengths produces a color with a red component that, although not bright, is pure and vivid. This color cannot be reproduced by a conventional display unless it uses a red light source that targets only the far end of the red spectrum, but then the display will be unable to produce bright red colors requiring a broader range of red wavelengths. The present embodiment can display both deep red colors and bright red colors.

As shown in FIGS. 18 and 19, since the first wavelength region R1 of the first red light R1 selected by the color selector 3 is narrower than the second wavelength region R2 of the second red light R2 selected by the color selector 3, the first red light R1 has a comparatively small amount of energy, and is comparatively dim. Accordingly, as shown in FIG. 20B, the light output from the light source 1 when the red color, including the first and second red light R1 and R2, is selected may have a smaller modulation index than when the green or blue light is selected; that is the third and fourth brightness levels GL2, GH2 do not have to be as widely separated as the first and second brightness levels GL1, GH1.

In the second embodiment, the brightness of light output from the light source 1 is modulated as in the first embodiment, and in addition, first red light R1 is used to display red pixels with comparatively low gray levels and both the first red light R1 and second red light R2 are used to display red pixels with higher gray levels, where the second red light R2 is both intrinsically brighter than occupies a wider wavelength region than the first red light R1. It is therefore possible to reduce the loss of gray levels caused by gray scale conversion, and also to broaden the gamut of reproducible colors.

The color selector 3 can be configured in various ways. It is not necessary for the color selector 3 to select light of just three primary colors, or for only the red light to include first light and second light spanning different wavelength regions. The color selector 3 may select more than three colors: for example, the color selector 3 may include a yellow filter Fy, cyan filter Fc, and magenta filter Fm in addition to the red filter Fr, green filter Fg, and blue filter Fb shown in FIG. 12, and yellow (Y), cyan (C), magenta (M) may be added to the three primary colors red green, and blue. Colors other than red may also by displayed by using first light of high color purity and second light with a broader wavelength region and higher brightness.

In these variations, when the color selector 3 selects light of each color, the gray scale data W supplied from the light valve controller 13 to the light valve 6 determine the on-duration of the selected light. To include these alternative configurations of the color selector 3, the color display of the present invention may be generalized as follows.

The color selector 3 successively selects light of N colors from the light output from the light source 1, where N is a positive integer. During an interval Pj during which the color selector 3 selects a Jth color among the N colors, the light source 1 outputs, at separate times, at least first light having a first wavelength region and second light having a second wavelength region wider than the first wavelength region, where J is an integer equal to or greater than one and equal to or less than N.

While the color selector 3 selects light of the Jth color having the first wavelength region, the light source 1 outputs light having a first brightness level, and while the color selector 3 selects light of the Jth color having the second wavelength region, the light source 1 outputs light having a second brightness level greater than the first brightness level.

The gray scale controller 12 converts the gray scale of the input color image data for the N colors to generate converted image data for the N colors.

The light valve 6 modulates the light of the color selected by the color selector 3 according to the converted image data output by the gray scale controller 12 for each pixel in the color image, thereby obtaining image light of the N colors. The light valve 6 modulates the light output when the color selector 3 selects a Kth color according to the color image data for the Kth color, where K is an integer equal to or greater than one and equal to or less than N.

If the light valve 6 outputs the image light by on-off pulse width modulation of the light selected by the color selector 3 for each pixel of the image, when the value of image data for the Jth color of a pixel expresses a gray level equal to or less than a predetermined level, the light valve 6 modulates only the first light GL2 to the on-state, and when the value of the image data for the Jth color of a pixel expresses a gray level greater than the predetermined level, the light valve 6 modulates both the first light GL2 output and the second light GH2 to the on-state.

The filter of a single color may be divided into three or more parts, to provide three or more types of light spanning different wavelength regions. For example, a series of gradually broadening wavelength regions may be provided. The line representing the luminance-to-data relation then bends at more than one point, and can be more closely tailored to match the desired input-output characteristic, further reducing the need for gray scale conversion and increasing the number of different gray levels that can be displayed.

When a monochrome image of one color is displayed by combining light with three or more wavelength regions, the light source 1 may be controlled to three or more brightness, adjusted according to the wavelength regions, with results as described as in the second embodiment.

It is not necessary to select the third brightness level GL2 of the first red light R1 output from the light source 1 and the fourth brightness level GH2 of the second red light R2 in consecutive intervals PC1 and PC2 as shown in the upper part of FIG. 21. The intervals PC1 and PC2 may be separate, or divided.

Selecting all light representing the same primary color consecutively as in the second embodiment has the advantage, however, of providing a brighter image, because it is also possible to use light transmitted partly through one filter and partly through another filter when the two filters represent the same primary color. In FIG. 20A, for example, the two parts R1, R2 of the red field R do not have to be temporally separated.

The light valve 6 need not operate by controlling light reflection time according to the value of the gray scale data W as in the embodiments described above. Any optical modulation method may be used. For example, the light valve 6 may operate by controlling light reflectance, light transmittance, or light transmitting time.

The invention is not limited to use in a projector that projects a color image on a screen. The invention is also useful in, for example, a direct-view liquid crystal display light valve.

Those skilled in the art will recognize that further variations are possible within the scope of the invention, which is defined in the appended claims.

What is claimed is:

1. A field sequential color display method for obtaining a color image by successively displaying a sequence of images in different colors, wherein;
the image displayed in at least one of the colors is displayed using first light with a first brightness and a first wavelength region and second light with a second brightness and a second wavelength region, the second brightness being greater than the first brightness; and
the image displayed in said at least one of the colors has a gray scale with a low part and a high part, the high part being brighter than the lower part, the low part of the gray scale being displayed by modulating the first light, the high part of the gray scale being displayed by modulating both the first light and the second light and combining the modulated first light and the modulated second light.

2. The field sequential color display method of claim 1, wherein the second wavelength region is identical to the first wavelength region.

3. The field sequential color display method of claim 1, wherein the second wavelength region includes the first wavelength region and a region contiguous with the first wavelength region.

4. The field sequential color display method of claim 1, wherein the first light and the second light are used during different time intervals.

5. The field sequential color display method of claim 1, wherein the first light and the second light are used during consecutive time intervals.

6. The field sequential color display method of claim 1, wherein the gray scale is converted so that the modulated first light and the modulated second light, taken in combination, have a desired gray scale characteristic.

7. A field sequential color display apparatus for obtaining a color image by successively displaying a sequence of images in different colors, comprising:
a gray scale converter for converting a gray scale of the input color image data to generate converted image data;
a light source for output of light for displaying the color image;
a color selector for successively selecting light with a series of different wavelength regions from the light output by the light source; and
a light valve for modulating the light with the wavelength region selected by the color selector according to the converted image data output by the gray scale converter for each picture element in the color image, thereby obtaining the displayed color image; wherein
the image has a gray scale with a low part and a high part, the high part being brighter than the lower part; and
while images of at least one of the different colors are being displayed, the light source generates first light with a first brightness and second light with a second brightness greater than the first brightness, the light valve modulates the first light to display the low part of the gray scale, and the light valve modulates both the first light and the second light to display the high part of the gray scale.

8. The field sequential color display apparatus of claim 7, wherein the color selector selects light of a first wavelength region while the light source outputs the first light, and selects light of a second wavelength region while the light source outputs the second light, the second wavelength region including the first wavelength region and a region contiguous with the first wavelength region.

9. The field sequential color display apparatus of claim 7, wherein the first light and the second light are used during consecutive time intervals.

10. The field sequential color display apparatus of claim 7, wherein the gray scale is converted so that the modulated first light and the modulated second light, taken in combination, have a desired gray scale characteristic.

11. A field sequential color display apparatus for displaying a color image by successively displaying a sequence of images in different colors according to input color image data for N colors, where N is a positive integer, comprising:
a light source for output of light for displaying the color image;
a color selector for successively selecting light of the N colors from the light output by the light source;
a gray scale converter for converting a gray scale of the input color image data for the N colors to generate converted image data for the N colors; and
a light valve for modulating the light of the color selected by the color selector according to the converted image data output by the gray scale converter for each picture element in the color image, thereby obtaining image light of the N colors; wherein
the gray scale has a low part and a high part, the high part being brighter than the lower part; and
while the color selector selects a Jth wavelength region among the N wavelength regions, the light source outputs, at separate times, at least first light having a first brightness and second light having a second brightness greater than the first brightness, the light valve modulates the first light to display the low part of the gray scale, and the light valve modulates both the first light and the second light to display the high part of the gray scale.

12. The field sequential color display apparatus of claim 11, wherein the color selector selects light of a first wavelength region while the light source outputs the first light, and selects light of a second wavelength region while the light source outputs the second light, the second wavelength region including the first wavelength region and a region contiguous with the first wavelength region.

13. The field sequential color display apparatus of claim 11, wherein the first light and the second light are used during consecutive time intervals.

14. The field sequential color display apparatus of claim 11, wherein the light valve outputs the image light by on-off pulse width modulation of the light selected by the light selector for each picture element of the image and wherein:
when the value of image data for the Jth color for the picture element expresses a gray level equal to or less than a predetermined level, the light valve modulates only the first light to the on-state; and
when the value of the image data for the Jth color for the picture element expresses a gray level greater than the predetermined level, the light valve modulates both the first light output and the second light to the on-state.

15. The field sequential color display apparatus of claim 11, wherein the gray scale converter converts the gray scale of the image data of the Jth color so that in the output image light obtained when the color selector selects the Jth color, the modulated first light and the modulated second light, taken in combination, have a desired gray scale characteristic.
